(19) United States
(12) Patent Application Publication
(10) Pub. No.: US 2021/0019826 A1
(43) Pub. Date: Jan. 21, 2021

(54) METHOD AND SYSTEM FOR PROVIDING ORDER ROUTING TO A VIRTUAL CROWD IN A HYBRID TRADING SYSTEM AND EXECUTING AN ENTIRE ORDER

(71) Applicant: Cboe Exchange, Inc., Chicago, IL (US)

(72) Inventors: Edward T. Tilly, Barrington, IL (US); Anthony Montesano, Chicago, IL (US); Eileen C. Smith, Chicago, IL (US)

(73) Assignee: Cboe Exchange, Inc., Chicago, IL (US)

(21) Appl. No.: 16/892,055

(22) Filed: Jun. 3, 2020

Related U.S. Application Data
(63) Continuation of application No. 16/133,293, filed on Sep. 17, 2018, now abandoned.
Application No. 16/133,293 is a continuation of application No. 15/018,418, filed on Feb. 8, 2016, now abandoned.
Application No. 15/018,418 is a continuation of application No. 12/267,035, filed on Nov. 7, 2008, now abandoned.
(60) Provisional application No. 60/986,727, filed on Nov. 9, 2007.

(51) Int. Cl. G06Q 40/04; G06Q 30/08

(52) U.S. Cl. CPC G06Q 40/04; G06Q 30/08

(57) ABSTRACT

A method of providing orders to a virtual trading crowd in an exchange prior to automatically linking the order to an away market includes receiving a marketable order at the exchange, wherein the exchange price differs from a national best bid or offer (NBBO) price, routing the order to a trade engine, disseminating a request for price message, the request for price message including a price equal to the NBBO price, receiving a response message, initiating a quote trigger, wherein the quote trigger occurs for a period of N seconds, allocating at least a portion of the order according to an allocation algorithm, wherein an order size of each market maker is capped to prevent inflation of an allocated portion of the order, and allocating any remaining portion of the order to at least one predetermined market maker guarantor for execution at the NBBO price.

### CROSS-REFERENCE TO RELATED APPLICATIONS

The present application is a continuation of U.S. patent application Ser. No. 16/133,293, filed Sep. 17, 2018, pending, which is a continuation of U.S. patent application Ser. No. 15/018,418, filed Feb. 8, 2016, abandoned, which is a continuation of U.S. patent application Ser. No. 12/267,035, filed Nov. 7, 2008, abandoned, which claims the benefit of U.S. Patent Application Ser. No. 60/986,727, filed Nov. 9, 2007, expired, wherein the entirety of each of these applications is hereby incorporated herein by reference.

### TECHNICAL FIELD

The present disclosure relates to the trading of securities or derivatives, such as options or futures. More particularly, the present disclosure relates to an exchange system and method and system for providing order routing to a virtual crowd in a system of concurrent trading of securities or derivatives through both electronic and open-outcry trading mechanisms.

### BACKGROUND

The introduction of electronic trading mechanisms into exchanges for securities and derivatives has been an ongoing process. The desire for immediacy of order execution and dissemination of information is one reason for the steady substitution to electronic mechanisms. As trading volume continues to grow, along with the accompanying need for an increasingly efficient trading environment, the move toward electronic trading mechanisms is favored.

Electronic exchanges, while efficient and nearly instantaneous, do not necessarily provide for the routing of orders to a trade engine for a “flash” to the virtual crowd instead of routing to a public automated routing (PAR) system. It is desirable for an exchange utilizing an open outcry component to provide a mechanism for the routing of orders to a trade engine for a “flash” to the virtual crowd instead of routing to a public automated routing (PAR) system for booking or automatically linking to an away market.

Currently national best bid or offer (NBBO) rejects, certain “tweeners” and orders that are marketable against away markets route to PAR. Once on PAR, the orders are represented to the open outcry crowd and, if not traded by the crowd, are either routed to the book (“tweeners”) or to an away market. Since manual handling is required for these orders and multiple orders may arrive at a single PAR workstation, there can be delays between the time the order arrives on PAR and the time the order is routed, booked or sent away for linkage to an away market. During the time period when an order rests on PAR, there is risk to both the customer and the PAR broker.

### BRIEF SUMMARY

In order to address the drawbacks of both traditional open outcry exchanges and electronic exchanges as they pertain to the trading of national best bid or offer (NBBO) rejects, certain “tweeners” and orders that are marketable against away markets, a trading platform and method is disclosed herein providing orders to a virtual trading crowd in an exchange prior to booking the order or automatically linking the order to an away market while providing assurance that an order will be fully executed.

According to a first aspect of the disclosure, a method is disclosed including receiving a marketable order for a security or derivative at the exchange, wherein the exchange has a price that differs from a national best bid or offer price. The marketable order is then routed to a trade engine, and a request for price message is transmitted to all market makers quoting a class in response to receiving the marketable order, where the request for price message includes a price equal to the national best bid or offer price. A response message is received at the electronic trade engine in response to the request for price message from at least one market maker, and a quote trigger is initiated, wherein the quote trigger occurs for a period of N seconds. The method also includes allocating at least a portion of the order to at least one market maker according to an allocation algorithm, wherein an order size of each market maker is capped to prevent inflation of an allocated portion of the order, and allocating a remaining portion of the order, if any, to at least one predetermined market maker guarantor to execute the remaining portion of the order at the national best bid or offer price.

According to another aspect of the disclosure, a method of providing orders to a virtual trading crowd in an exchange prior to booking the order is disclosed, the method including receiving an order at the exchange, wherein the exchange has a price that differs from a national best bid or offer price and wherein the order is not marketable upon receipt, routing the order to a trade engine, transmitting a request for price message to all market makers quoting a class in response to receiving the order, the request for price message including a price equal to the national best bid or offer price. The method also includes receiving a response message at the electronic trade engine in response to the request for price message from at least one market maker, initiating a quote trigger, wherein the quote trigger occurs for a period of N seconds, allocating at least a portion of the order to at least one of the at least one market maker according to an allocation algorithm, wherein an order size of each market maker is capped to prevent inflation of an allocated portion of the order. A remaining portion of the order, if any, is allocated to at least one predetermined market maker guarantor to execute the remaining portion of the order at the national best bid or offer price.

In yet another aspect of the disclosure, an automated system for providing orders to a virtual trading crowd in an exchange configured for trading securities or derivatives is disclosed including an electronic trade engine configured for receiving an order for a security or derivative at the exchange having a price that differs from a national best bid or offer price, wherein the trade engine disseminates a request for price message to all market makers quoting a class in response to receiving the order, the request for price message including a price equal to the national best bid or offer price. An electronic book is configured to store at least one order received by the electronic trade engine. A database comprising an allocation algorithm and market maker guarantor designations is in communication with the electronic trade engine, and a trade processor in communication with the database is operative to analyze and execute orders according to the allocation algorithm selected from the database. The trade processor comprises a quote trigger that occurs for a period of N seconds and allocating a remaining portion of the order, if any, to at least one predetermined market maker guarantor selected from the database to execute the remaining portion of the order at the national best bid or offer price.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is a diagram of one embodiment of a hybrid exchange system merging screen-based electronic orders with traditional open-outcry floor trading.

FIG. 2 is a block diagram of one embodiment of the electronic trading engine of FIG. 1.

FIG. 3 is a flow diagram of one embodiment of a method for providing order routing to a virtual crowd in a hybrid trading system.

### DETAILED DESCRIPTION OF THE DRAWINGS

A system and method for trading securities, such as securities options is described herein. The trading mechanisms and rules described are based on providing incentives or limitations to particular classes of individuals or entities who are involved in trading at an exchange. For purposes of this specification, the following definitions will be used:

Broker/dealer—person or entity registered to trade for itself and/or on behalf of others at the exchange.

Public customer—person or entity, who is not a broker/dealer, trading on their own behalf through a broker/dealer or firm registered to trade at the exchange.

Firm—entity employing persons who represent the firm, or the firm's customers, on the exchange, such as market makers, floor brokers, broker/dealers, or other industry professionals.

Market maker—professional trader registered to trade at the exchange who is required to provide liquidity to a market, for example through streaming quotes for both a bid and an offer at a particular price.

Designated primary market maker (DPM)—market maker designated by the exchange to be responsible for a fair and orderly market, and to provide continuous quotes, for a particular class of options.

Floor broker—individual who represents orders from others in a trading crowd on the floor of an exchange.

Market participant—any person or entity that can submit orders or quotes to an exchange.

In-crowd market participant (ICM)—floor broker, market maker or designated primary market maker physically present on the floor of the exchange.

Non-in-crowd market participant (non-ICM)—market participants who are not physically present on the floor of the exchange.

Class of options—all series of options related to a given underlying security, where the underlying security may be, for example, publicly traded stock of a company.

Tweener—Order on a trading system that is represented to the open outcry crowd and, if not traded by the crowd, that is routed to the book.

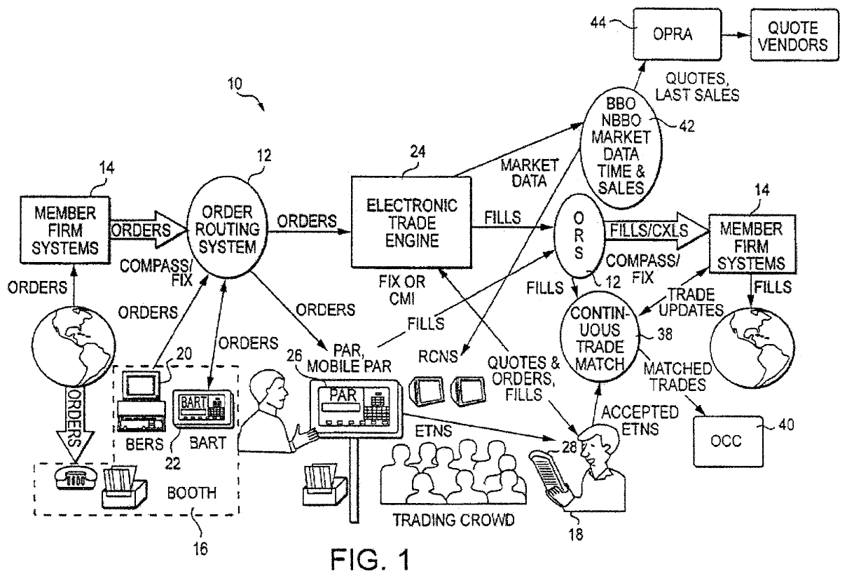

Referring to FIG. 1, one embodiment of an exchange system combining aspects of electronic, screen-based trading with traditional, open-outcry trading suitable for implementing various securities and derivatives trading methods described herein is illustrated. The system 10 receives order information for the purchase or sale of securities, for example derivatives such as stock options, from numerous sources at a central order routing system (ORS) 12. ORS 12 may be any of a number of data processing systems or platforms capable of managing multiple transactions, as are well known in the art. For example, in one embodiment, the order routing system can be implemented on a transaction processing facility (TPF) platform manufactured by IBM Corporation. For purposes of clarity, the examples herein will refer specifically to options. However, it will be appreciated that the system and methods disclosed herein might be applied to the trading of other types of securities and derivatives.

Accordingly, an exchange utilizing the system and methods described herein may manage a number of classes of derivatives, where each of the plurality of classes of derivatives are associated with an underlying asset such as a stock, a bond, a note, a future, an exchange traded fund, an index, a commodity or other known asset types.

Information, such as orders may be entered into the ORS 12 from remote member firm systems 14, from member firm's booths 16 physically located at the exchange system 10 and from market makers 18 present on the trading floor of the exchange. The member firm systems 14 may be located remotely from the geographical location of the exchange and use any of a number of standard landline or wireless communication networks to direct orders electronically to the ORS 12. The member firm systems 14 communicate with one of several interfaces or protocols for transmitting their orders to the ORS 12. Examples of suitable interfaces are those using a distributed object interface based on the CORBA standard and available from the Object Management Group. Interfaces such as financial information exchange (FIX), which is a message-based protocol implemented over TCP/IP available from FIX Protocol, Ltd., or other known securities transaction communication protocols are also suitable protocols. In some instances, orders may even be made by telephone calls or facsimile transmissions directly to the booths 16 of member firms at the exchange. Orders submitted from a booth 16 at the exchange may come from a booth entry and routing system (BERS) 20 or a booth automated routing terminal (BART) 22.

The BERS 20 is a computer workstation that provides firm staff members at the booth with an entry template and a graphic user interface with a number of function buttons arranged on the display. Orders entered at the booth through BERS 20 typically consist of orders that were telephoned to the booth and orders that were wired to member firm-owned house printers in the booth. The orders entered through BERS are done so manually by booth staff using an order template and graphic user interface on the workstation. Generally, an order entered at BERS 20 will be routed to the ORS 12. Member firms, however, may specify that a particular order entered through BERS be routed to the BART 22 device. The BART 22 device, sometimes referred to as the “electronic runner,” allows member firms to maintain more control over their order flow. BART 22 allows each firm to customize certain ORS 12 parameters to route a certain portion of their order flow to the firm booth. For example, firms may instruct ORS 12 to send certain orders directly to their booths 16 based on the size of the order.

As with the BERS 20, BART 22 may be implemented on a touch-screen workstation located in the member firm booth. The BART 22 operator at the booth may electronically forward orders to desired destinations. Potential destinations for these booth-routed orders are the ORS 12, the electronic trade engine 24 in communication with the ORS 12, or the public automated routing (PAR) system 26 used by the floor brokers at the exchange. The PAR system 26 may be implemented as a PC-based, touch-screen order routing and execution system accessible by floor brokers on the floor of the exchange.

In one embodiment, the PAR system 26 may be accessible by a floor broker inputting a broker-specific identifier therein. The broker-specific identifier is preferably a personal identification number (PIN) or other coded identifier known and specific to the floor broker. Once accessed by the floor broker, the PAR system 26 terminals, for example, allow a floor broker to select an order from the workstation and receive an electronic trading card or template on which the floor broker may enter trade information such as its volume, price, opposing market makers, or the like. When a floor broker completes an electronic template, the floor broker can then execute a trade electronically with the touch of a finger on the touch screen interface. The PAR system 26 then transmits the completed order, also referred to as a “fill,” back to the ORS 12. The ORS 12 can then mark the completed order with the broker's broker-specific identifier to associate a particular order with a specific broker. This benefits the broker by permitting the broker to demonstrate which orders she handled so that a charge may be passed on to the customer. The PAR 26 may be a fixed workstation or a mobile workstation in the form of a hand-held unit.

When a trade is completed, whether on the floor in open outcry and entered into PAR 26 or automatically executed through the electronic trade engine 24, the fill information is sent through the electronic trade engine 24 and ORS 12. ORS 12 passes the fill information to the member firm systems and to a continuous trade match (CTM) system 38 which matches the buy side and sell side of a trade which, in turn, forwards the matched trades to the Options Clearing Corporation (OCC) 40, a third party organization that will verify that all trades properly clear. The electronic trade engine 24 also sends quote and sale update information through an internal distribution system 42 that will refresh display screens within the exchange 10 and format the information for submission to a quote dissemination service such as the Options Price Reporting Authority (OPRA) 44.

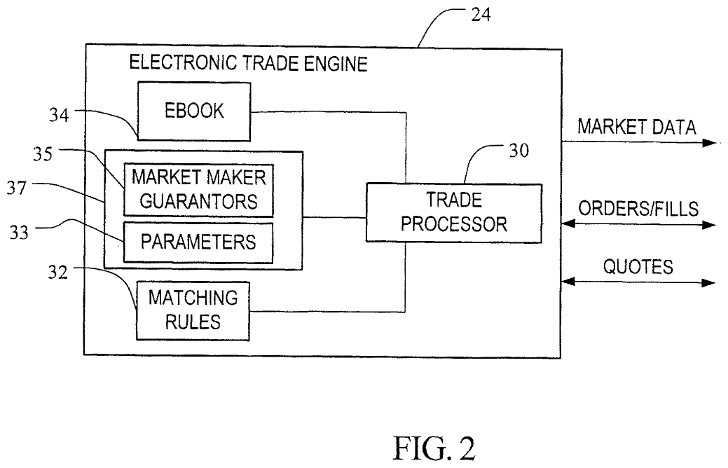

As illustrated in FIG. 2, an electronic trade engine 24 contains a trade processor 30 that analyzes and manipulates orders according to matching rules 32 stored in the database in communication with the trade processor 30, as described in co-pending U.S. patent application Ser. No. 10/423,201, the entirety of which is hereby incorporated by reference. Also included in the electronic trade engine is the electronic book (EBOOK) 34 of orders and quotes with which incoming orders to buy or sell are matched with quotes and orders resting on the EBOOK 34 according to the matching rules 32. In an embodiment, upon a match, the electronic trade engine 24 will mark the matched order or quote with the broker-specific identifier so that the broker sending the order or quote information can be identified. The electronic trade engine 24 may be a stand-alone or distributed computer system. Any of a number of hardware and software combinations configured to execute the trading methods described below may be used for the electronic trade engine 24. In one embodiment, the electronic trade engine 24 may be a server cluster consisting of servers available from Sun Microsystems, Inc., Fujitsu Ltd. or other known computer equipment manufacturers. The EBOOK 34 portion of the electronic trade engine 24 may be implemented with Oracle database software and may reside on one or more of the servers comprising the electronic trade engine 24. The rules database 32 may be C++ or java-based programming accessible by, or executable by, the trade processor 30.

When a trade is completed, whether on the floor in open outcry and entered into PAR 26 or automatically executed through the electronic trade engine 24, the fill information is sent through the electronic trade engine 24 and ORS 12. ORS 12 passes the fill information to the member firm systems and to a continuous trade match (CTM) system 38 which matches the buy side and sell side of a trade which, in turn, forwards the matched trades to the Options Clearing Corporation (OCC) 40, a third party organization that will verify that all trades properly clear. The electronic trade engine 24 also sends quote and sale update information through an internal distribution system 42 that will refresh display screens within the exchange 10 and format the information for submission to a quote dissemination service such as the Options Price Reporting Authority (OPRA) 44.

The exchange system 10 may be configured to incorporate quote trigger functionality to permit greater participation in trades. The quote trigger would automatically be invoked when a new better price is entered so that additional market participants may have a limited time in which to enter quotes at a price matching the new better price and obtain a portion of the order. For example, upon detecting a quote from a market participant at a new best price which would match against an order on the electronic book from a non-ICM, the electronic trade engine 24 will remove the quantity of the resting order that would be tradeable against the incoming quote and hold it and the incoming quote for a predetermined period of time. Any desired preset hold period may be used, however in one embodiment it is contemplated that a five second hold period is used. In other embodiments, the hold period may be fixed anywhere in the range of 0.5-5.0 seconds. After removing the quantity of the resting order, the electronic trade engine 24 will treat the removed quantity of resting order as having been sold and disseminate a last sale market data message so that the OPRA system 44 will indicate the trade has taken place (at step 90). The electronic trade engine 24 will update the top-of-the-market (i.e. update the quote) as though the trade had immediately occurred (at step 92).

During the hold period, any other quotes or orders from market participants that would also be marketable against the original resting order are gathered and the resting order volume at the current best price will be further reduced, if any still remains in the book. At the expiration of the hold period, the accumulated in-crowd market participant quotes and orders are traded against the resting orders. If the size of the resting order was greater than the size of the sum of the market participant quotes and orders, each of the quotes and orders would execute fully against the resting order. If the size of the resting order is less than the sum of the market participant quotes and orders, the resting order is allocated among the quotes and orders according to the matching algorithms discussed above. The electronic trade engine will then send fill reports of the executed trades to the ORS 12 for distribution to the appropriate source of the quotes or orders involved.

### NBBO Rejects

If an incoming order is marketable, but the exchange is not the NBBO, the ORS 12 will utilize routing parameters that permit NBBO reject orders to route to the electronic trade engine 24, as well as the PAR system 26 or BART 22, on a class and origin basis. Orders that are routed to the PAR system 26 or BART 22 will be handled as described above. NBBO reject orders that are routed to the electronic trade engine 24 will be handled as described below.

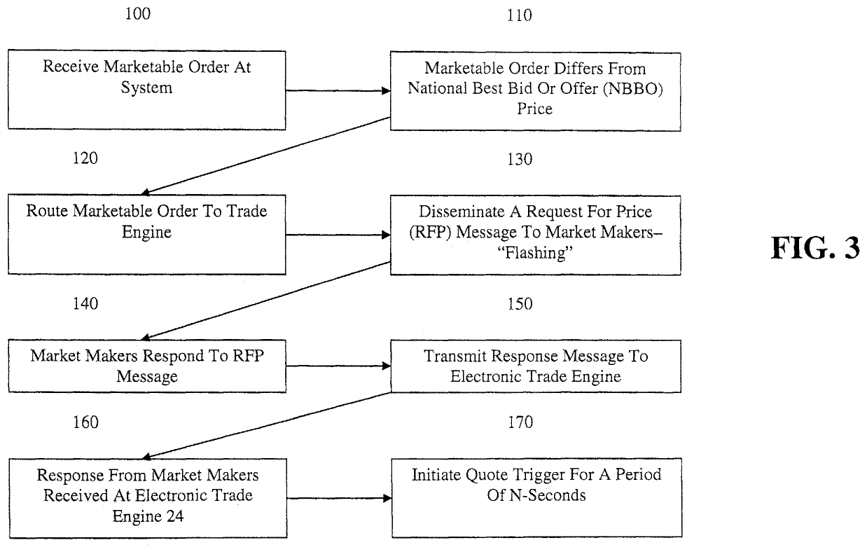

Referring now to FIG. 3, a method of providing orders to a virtual trading crowd in an exchange prior to automatically linking the order to an away market is illustrated. As shown, a marketable order (an order that is marketable at an away market) for a security or derivative is received at the exchange (step 100), the exchange having a price for the security or derivative that differs from a national best bid or offer price. The marketable order is routed to the trade engine 24 (step 120), where a Request for Price (“RFP”) message is disseminated (“flashing,” as detailed below) to a plurality of market makers 18 quoting a class (step 130), which as detailed below, can include information such as the starting (and trading) price, as well as the side and size of the order. At least one of the market makers 18 responds to the RFP message (step 140) and transmits a response message to the electronic trade engine 24 (step 150). The response message, which is a message indicating the market makers' 18 response to the RFP message, is received at the electronic trade engine 24 (step 160), and a quote trigger is initiated, with the quote trigger occurring for a period of N seconds (step 170).

In accordance with an embodiment, any existing quote locks, quote triggers or auctions for quotes and offers at the NBBO will end and will be allocated prior to the start of any “flashing” of NBBO reject orders to market makers quoting in the class. In one embodiment, “flashing” is accomplished by transmitting a Request for Price (“RFP”) to the market makers quoting in the class. The system 10 may retain a record of all market makers quoting at the best price as well as the firm quote obligation when the RFP is sent. This is referred to as the “flash” phase. In one embodiment, the RFP includes the NBBO price as the starting (and trading) price, as well as the side and size of the order. The flash phase will last for a period of N second(s), where N may be a fixed or variable time period, or until the first RFP response is received, whichever is shorter. Typically, the flash phase period is the same for all three flash types described herein. In one embodiment, the N second period is less than 5 seconds. In other embodiments, it is contemplated that each flash type (e.g. NBBO reject, Tweener, etc.) may be assigned a different time period. In yet other embodiments, the time period may be variable based on the current number of market makers in the quoting class, the number of contracts involved or other instantaneous or historical statistic relating to the class of options being traded.

Unlike other RFPs, the NBBO price is not a starting price for an auction. Instead, the NBBO is typically the price that the order will be traded at even if a quote moves to a better price or an RFP response is received at a better price. Essentially, the order is treated as though it has been booked at the NBBO price. As with other RFP responses, these will not be displayed as part of the disseminated quote. Once the first response is received from a market maker at the appropriate price (either a quote, an In Crowd Market Maker order, also referred to as an I-order or an RFP response) the second phase (the “trigger” phase) will be started. During the trigger phase, a quote trigger will be started for N-seconds. In one embodiment, a last sale price will be disseminated immediately. Quotes, I-orders and RFP responses may be included in the quote trigger group.

In one embodiment, the order will be allocated using a matching algorithm, referred to herein as the Capped Ultimate Matching Algorithm (CUMA). In CUMA, the allocation algorithm will typically be configurable by class and/or by auction-type. For example, matching algorithms can be used to allocate an incoming order to participants based on the number of participants and the order size each participant represents. Furthermore, orders are preferably allocated to the multiple market participants quoting at the same price based on two components: an ‘A’ component, or parity factor, and a ‘B’ component, or pro rata/depth of liquidity factor. The parity factor of the matching algorithm treats as equal all market participants quoting at the relevant best bid or offer (BBO). Thus, if there were four market participants quoting or bidding at the best price, each would be assigned 25 percent for the parity component of the matching algorithm. Viewed in conjunction with the pro rata factor of the algorithm, the parity component of the algorithm provides incentive to market participants to quote at a better price than their competitors even though they may have a smaller quote size than other market participants quoting at the BBO.

The second component of CUMA rewards those quoting larger sizes at the best price by providing the market participants a pro rata component based on the percentage of the volume of that market participant's quote size with reference to the sum of the total of all quote sizes at the best price, with the added feature that certain participants are limited in the size of their order that will be used to calculate the ‘B’ component of the equation. For example, if the disseminated quote represents the quotes of market makers x, y, and z who quote for 20, 30, and 50 contracts respectively, then the percentages assigned under the pro rata component are 20% for x, 30% for y, and 50% for z. The final allocation may then be determined by multiplying the average of the A and B components by the size of the incoming order available. In one embodiment, the matching algorithm described above produces the following equation:

$$Participant ' s allocation = incoming order size \times [ \frac{\frac{1}{number of participants} + \frac{participant quote size}{{Σ}^{\underline{participant quote sizes}}}}{2} ]$$

Thus, for example, where certain participants are limited in the size of their order that will be used to calculate the ‘B’ component of the equation, participants such as In Crowd Market Makers (ICMs) may be capped in this way so that, after other participants have already entered their order or quotes, the ICM cannot inflate the size of its order to obtain a greater pro rata weighting (and thus greater allocation) of the available order.

Additionally, all responses (including quotes, I-orders and RFP responses) from a single market maker will typically be aggregated for the purposes of calculating the ‘A’ component of CUMA. A participation filter may be used by the trading engine to determine which market participants can or cannot participate in the quote trigger. For example, the electronic trade engine may be configured to permit all non-customers to participate in the quote trigger process by recognizing a participant identifier associated with non-customers. In other implementations the electronic trade engine may be programmed to only allow ICMs to participate in a quote trigger.

If non-customers were included in the quote trigger process based on this filtering mechanism, an incoming order under the ‘B’ component could start the quote trigger after the RFP period is started. Additionally, an incoming ‘B’ component of the order would participate in the quote trigger, rather than trading at the next price. It is anticipated that customers will continue to trade as they do today.

Once the flash phase begins, if a marketable customer order is received that could trade against the flashed order, the orders will trade against each other immediately with any balance routing to the appropriate destination. If a customer order is received during the trigger phase, it may trade at the next available price or route to the appropriate destination.

If the away market moves during the flash phase and the exchange becomes the NBBO, the flash phase will end and the order will be automatically traded and allocated to the market makers on the quote. If an away market moves to a better price during the flash phase, the flash phase will end and the order will route to the PAR 26 for auto-linking. Since market makers may have a firm quote obligation during the N-second flash phase, if the exchange market makers move quotes such that there is no longer enough size to fill the incoming order up to the original disseminated size, the order will be routed to the PAR 26 and sent to an away exchange immediately using auto-link functionality.

If the flash phase ends and there are no responses, the order will route to the PAR 26 to automatically link away from the exchange to another exchange. In the unlikely circumstance that the order cannot be routed away once it is received on the PAR 26 due to either: (1) a lack of an away market at a better price, or (2) the ORS 12 rejects that order because the away market is no longer available after the PAR 26 attempts to send the linkage order, the PAR 26 will automatically route the order back to the electronic trade engine 24 where it will be filled at the original firm quote price up to the original firm quote size.

In one embodiment, the order may be filled in one of the following ways:

If there are market makers on the market that can fulfill the firm quote obligation (the original price and size or better) the order will be assigned to them. Alternatively, if there is more size required to fulfill the firm quote obligation, the order will be assigned to those quoters who comprised the firm quote at the time the order was received. Since the electronic trade engine 24 will have to keep track of the participants that were on the original market, it is contemplated that an additional mechanism may be required so that the electronic trade engine 24 does not have to store the information indefinitely.

In one embodiment, a market maker guarantor may be designated to fill orders not fully executed (and therefore have a remaining portion). Such a designated market maker guarantor assures that there will be an NBBO execution for the remaining portion of orders from a submitting firm that are not fully executed after the exposure and allocation periods have concluded (detailed above). There may be one or more predetermined market maker guarantors and each market maker guarantor may set parameters 33 on their execution guarantees including but not limited to order size, price, size of a displayed national best bid or offer, which exchanges are displaying the national best bid or offer, transaction costs, and a number of increments from an exchange best bid or offer. Market maker guarantors may set only one or any combination of these parameters 33, which parameters 33 may then be stored in a database of the exchange system 10. The market maker guarantor designations 35, i.e. the market makers designated as guarantors, and the parameters 33 set by the market maker guarantors may both be stored in a guarantor database 37 in communication with the trade processor 30, as detailed herein above, so that the trade processor 30, in communication with both the rules database 32 and the guarantor database 37, can be operative to analyze and execute orders according to the allocation algorithm selected from the rules database 32 and allocate a remaining portion of the order, if any, to at least one predetermined market maker guarantor selected from the guarantor database 37 to execute the remaining portion of the order at the national best bid or offer price.

Preferably, the remaining portion of the order is automatically allocated to the market maker guarantor if the remaining portion meets the parameters 33 set by the market maker guarantor. A notification may be sent by the exchange system 10 to the market maker guarantor upon the automatic allocation of the remaining portion of the order. It is also contemplated that, in the event that the remaining portion of the order exceeds the order size that a market maker guarantor is willing to guarantee, the remaining portion of the order may be divided among more than one market maker guarantor so that the entire remaining portion may be executed at the NBBO. Alternatively, it may be desired that, if the remaining portion of the order exceeds the order size that a market maker guarantor is willing to guarantee, the remaining portion is not executed against the market maker guarantor.

“Tweener” Locks

An incoming order that is between the market at the exchange, but is marketable against an away market is commonly referred to as a “tweener lock.” The “tweener lock” order cannot be booked because it would lock or cross an away market. In one embodiment, the ORS 12 comprises routing parameters to allow tweener locks to route to the electronic trade engine 24, the PAR 26 or BART 22 based on class and origin. Orders that are routed to the PAR 26 or BART 22 will preferably be handled in a manner consistent with the current state of the art, such as described in co-pending U.S. patent application Ser. No. 10/423,201, referenced above. Orders that are routed to the electronic trade engine 24 will typically be handled as described above for NBBO rejects, with the exception that there is no firm quote obligation. Thus, the requirements of the firm quote will typically not be followed. If there are no responses during the flash phase, the order will route to the PAR 26 to be automatically linked away. If the order cannot be linked away, it will automatically route back to the electronic trade engine 24 for booking.

“Tweeners”

An incoming order that is between the market at the exchange and does not lock or cross an away market is commonly referred to as a “tweener.” In one embodiment, the ORS 12 comprises parameters used to route tweeners to the electronic trade engine 24, the PAR 26 or BART 22 based on class and origin code. Orders that are routed to the PAR 26 or BART 22 will typically be handled in a manner consistent with the current state of the art, such as described in co-pending U.S. patent application Ser. No. 10/423,201, referenced above. Orders that are routed to the electronic trade engine 24 will be handled as described above for NBBO rejects, with the exception that there is no firm quote obligation. Thus, the requirements of the firm quote will not be followed. If there are no responses during the flash phase, the order will typically be booked automatically.

As has been described above, the hybrid exchange system merges electronic and open outcry trading models while at the same time offering a trading platform and method for providing orders to a virtual trading crowd in an exchange prior to booking the order or automatically linking the order to an away market.

Although the system and methods described herein relate to a hybrid system incorporating and involving active participation from a trading floor and a screen-based electronic trading crowd, many of the procedures described may be applied to an exclusively electronic, screen-based exchange that does not include floor based, open-outcry trading. As will be appreciated by those of ordinary skill in the art, mechanisms for providing orders to a virtual trading crowd in an exchange prior to booking the order or automatically linking the order to an away market and other features described above may all be modified for application to electronic-only trading within the purview and scope of the present invention. An advantage of the disclosed system and methods is that more traders at the exchange may have more opportunity to see and compete for orders that are NBBO rejects, tweener locks or tweeners, thus increasing visibility of orders and the desirability of maintaining a presence at the exchange.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. It is therefore intended that the foregoing detailed description be regarded as illustrative rather than limiting, and that it be understood that it is the following claims, including all equivalents, that are intended to define the scope of this invention.

What is claimed is:

1. A method of providing orders to a virtual trading crowd in an exchange prior to automatically linking the orders to an away market, the method comprising:
receiving an order for a security or derivative at the exchange, wherein the exchange comprises a price for the security or derivative that differs from a national best bid or offer price;
routing the order to a trade engine;
transmitting a request for price message from the trade engine to a plurality of market makers quoting a class;
receiving at least one response message from at least one market maker of the plurality of market makers at the electronic trade engine;
initiating a quote trigger, wherein the quote trigger occurs for a period of N seconds; and
allocating at least a portion of the order by the trade engine to at least one market maker according to an allocation algorithm, wherein an order size of each market maker is capped to prevent inflation of an allocated portion of the order; and
allocating a remaining portion of the order by the trade engine, if any, to at least one predetermined market maker guarantor to execute the remaining portion of the order at the national best bid or offer price.

2. The method according to claim 1, wherein the request for price message comprises a price equal to the national best bid or offer price.

3. The method according to claim 2, wherein the request for price message further comprises an order size.

4. The method according to claim 1, wherein the market maker guarantor sets execution parameters for the remaining portion of the order, the execution parameters comprising at least one of order size, price, size of a displayed national best bid or offer, which exchanges are displaying the national best bid or offer, transaction costs, or a number of increments from an exchange best bid or offer.

5. The method according to claim 4, wherein the allocation algorithm comprises a participation component and a pro rata component for each market maker sending a response message.

6. The method according to claim 5, wherein the allocated portion is the pro rata component.

7. The method according to claim 6, wherein the allocation algorithm comprises a relation:
$$\begin{matrix}Participant ' s allocation of \\ incoming \\ order \end{matrix} = incoming order size \times [ \frac{\frac{1}{number of participants} + \frac{participant quote size}{Σ participant quote sizes}}{2} ] ,$$
wherein the participation component and the pro rata component are equally weighted.

8. A method of providing orders to a virtual trading crowd in an exchange prior to booking the orders, the method comprising:
receiving an order at the exchange, wherein the exchange comprises a price that differs from a national best bid or offer price and wherein the order is not marketable upon receipt;
routing the order to a trade engine;
transmitting a request for price message from the trade engine to a plurality of market makers quoting a class;
receiving a response message at the electronic trade engine from at least one market maker of the plurality of market makers;
initiating a quote trigger, wherein the quote trigger occurs for a period of N seconds;
allocating at least a portion of the order by the electronic trade engine to at least one of the at least one market maker according to an allocation algorithm, wherein an order size of each market maker is capped to prevent inflation of an allocated portion of the order; and
allocating a remaining portion of the order by the electronic trade engine, if any, to at least one predetermined market maker guarantor to execute the remaining portion of the order at the national best bid or offer price.

9. The method according to claim 8, wherein the request for the price message comprises a price equal to the national best bid or offer price.

10. The method according to claim 9, wherein the request for the price message further comprises an order size.

11. The method according to claim 8, wherein the allocation algorithm comprises a participation component and a pro rata component for each market maker.

12. The method according to claim 11, wherein the allocated portion is the pro rata component.

13. The method according to claim 11, wherein the allocation algorithm comprises a relation:
$$\begin{matrix}Participant ' s allocation of \\ incoming \\ order \end{matrix} = incoming order size \times [ \frac{\frac{1}{number of participants} + \frac{participant quote size}{Σ participant quote sizes}}{2} ]$$
wherein the participation component and the pro rata component are equally weighted.

14. The method according to claim 8, wherein the market maker guarantor sets execution parameters, the execution parameters comprising at least one of order size, price, size of a displayed national best bid or offer, which exchanges are displaying the national best bid or offer, transaction costs, or a number of increments from an exchange best bid or offer.

15. An automated system for providing orders to a virtual trading crowd in an exchange configured for trading securities or derivatives comprising:
an electronic trade engine operative to receive an order for a security or derivative at the exchange, wherein the exchange comprises a price for the security or derivative that differs from a national best bid or offer price, the trade engine further operative to disseminate a request for a price message to a plurality of market makers quoting a class in response to receiving the order;
an electronic book in communication with the electronic trade engine, the electronic book operative to store at least one order received by the electronic trade engine;
a database comprising an allocation algorithm and market maker guarantor designations, the database in communication with the electronic trade engine; and
a trade processor in communication with the database, the trade processor operative to analyze and execute orders according to the allocation algorithm selected from the database, the trade processor comprising a quote trigger that occurs for a period of N seconds and allocating a remaining portion of the order, if any, to at least one predetermined market maker guarantor selected from the database to execute the remaining portion of the order at the national best bid or offer price.

16. The automated system of claim 15, wherein the request for the price message comprises a price equal to the national best bid or offer price.
